(19) United States
(12) Patent Application Publication
(10) Pub. No.: US 2007/0154807 A1
(43) Pub. Date: Jul. 5, 2007

(54) Nanostructural Electrode and Method of Forming the Same

(76) Inventors: Yevgen Kalynushkin, Pompano Beach, FL (US); Peter Novak, Ft. Lauderdale, FL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/617,925

(22) Filed: Dec. 29, 2006

Related U.S. Application Data
(60) Provisional application No. 60/755,621, filed on Dec. 30, 2005.

(51) Int. Cl. H01M 4/02; H01M 4/62; B05D 5/12; B05D 1/02

(52) U.S. Cl. 429/209; 429/232; 427/122; 427/427

(57) ABSTRACT

An electrode and method of forming the same of the present invention is used for the high-rate deposition of materials, such as carbon, silicon, metals, metal oxides, and the like, onto a metal substrate defined by a metal tape used as cathode or anode combined with a separator to form a fuel cell of a secondary battery, metal-ceramic membranes, film composite metal-ceramaic materials for electronic devices. The method is cost effective and is directed to form the electrode with improved and high porosity.

### FIELD OF THE INVENTION

This application claims priority to a provisional patent application Ser. No. 60/755,621 filed on Dec. 29, 2005 and incorporated herewith by reference in its entirety.

### FIELD OF THE INVENTION

The subject invention relates to an apparatus and method for manufacturing an electrode for a cell having improved cell charged capacity, C-rate performance and recycling stability.

### BACKGROUND OF THE INVENTION

The term “nanotechnology” generally refers to objects, systems, mechanisms and assemblies smaller than one ten of micron and larger than 1 nm. In recent years nanotechnology has been used to make products, that is, raw materials are processed and manipulated until the desired product is achieved. In contrast, nanotechnology mimics nature by building a product from the ground up using a basic building block—the atom. In nanotechnology atoms are arranged to create the material needed to create other products. Additionally, nanotechnology allows for making materials stronger and lighter such as carbon nanotube composite fibers.

One of the areas of continuous development and research is an area of energy conversion devices, such as for example secondary batteries capable of charging electricity after discharge and having at least one electrochemical cell. The cell includes a pair of electrodes and an electrolyte disposed between the electrodes. One of the electrodes is called a cathode wherein an active material is reduced during discharge. The other electrode is called an anode wherein another active material is oxidized during discharge. Secondary batteries refer to batteries capable of charging electricity after discharge.

The typical lithium metallic or lithium ion battery has an anode containing an active material for releasing lithium ions during discharge. The active material may be metallic lithium and an intercalated material being capable of incorporating lithium between layers. The active material is deposited or coated upon a metal current collector formed from a metal tape to increase electro-conductive characteristics of at least one of the electrodes. The lithium-ionic secondary battery are known to be the most widely used energy sources for electronic and electrical devices of the kind. The carbonic materials are most often used as active substances in anodic and cathode electrodes of the aforementioned batteries.

Alluding to the above, the prior art method of fabrication carbon based electrodes is on deposition by rolling a mixture of carbonic fragments upon a metallic surface of the electrode with application of an organic binder. Thus, the carbon particles or carbonic particles have a mechanical contact with one another and absorb the organic binder, which presents the dielectric properties and degrades electrochemical parameter of the electrodes. Those skilled in the battery art, however, will appreciate that the presence of the binder is necessary to provides coupling between the carbonic fragments of the active material of the electrodes. This method fails to provide the electrodes for the cell having high speeds of a charge and discharge because of high electric resistance between the fragments of active substance and between the fragments and the metal current collector thereby resulting in general and common impedance of the system negatively impacting the usage of high currents of the charge and discharge. The volumetric changes in graphite and other forms and shapes of existence of carbon at the reversible intercalation of lithium ions present another problem such as destruction of carbonic fragments and loss of an electrical contact between them.

The art is replete with various methods and devices for obtaining of carbonic electrodes. The U.S. Pat. No. 5,700,298 to Shi et al. teaches the method of increasing the percentage of the 3R phase present in graphite that reduces the first capacity loss of anodes employing the so modified graphite. Conversion of 2H phase graphite to 3R phase graphite is achieved by grinding graphite thereby fabricating non-aqueous solid electrochemical cells by employing intercalation based carbon anodes comprising graphite with high percentage of 3R. When employed in an electrochemical cell, the first cycle capacity loss of only about 10%.

The increase of capacity of anodic electrodes can be reached by usage as an active materials the particular forms or shapes of the carbon existence such as, for example fullerens, as suggested by the U.S. Pat. No. 6,146,791 to Loutfy et al., nano fibers and fragment of different morphology as taught by the United States Application Publication Nos. 20010031238 to Omaru et al., and 20020197534 to Fukuda et al. Other methods known for obtaining nano structural carbon particles are a pyrolysis method, a method of plasma sputtering in the air or in the inert gas, laser sputtering method, a melectric discharge, plasma chemical deposition from a vapor phase, thermal chemical deposition, electrolysis, flame-synthesis etc. The predominant application of nano structural carbonic powders is stipulated by their large specific surface and by the fact, that the small-sized fragments experience some smaller volumetric changes in process of electrode cycling.

Numerous other methods have been proposed by the prior art to increase of specific capacity of carbonic electrodes based on saturation of nano fibers by metals, such as the method taught by the United States Application Publication No. 20030008212 to Akashi et al. or the usage of composite materials consisting of the carbonic nano fragments and lithium metallic oxides, as taught by the United States Application Publication No. 20030003362 to Leising. However, all these methods fails to ensure the high speed of the discharge and the charge of the battery because to the availability of the dielectric binding and mechanical contact between the fragments. Moreover, the presence of the binder limits the temperature interval of usage of lithium-ionic batteries, because the raise of the temperature emolliates the binding effect thereby resulting in formation of conglomerates of active material, the loss of a contact between them, distortion of an electrical field inside of an electrode.

There are numerous methods of obtaining of the electrodes without an organic binder. One of these methods is suggested by the U.S. Pat. No. 5,426,006 to Delnick et al., which teaches a secondary battery having a rechargeable lithium-containing anode, a cathode and a separator positioned between the cathode and anode with an organic electrolyte solution absorbed therein is provided. The anode comprises three-dimensional microporous carbon structures received by carbonization of a porous polymer material.

Another method is taught by the U.S. Pat. No. 6,436,576 to Hossain, wherein a secondary electrochemical cell comprises a body of aprotic, non-aqueous electrolyte, first and second electrodes in effective electrochemical contact with the electrolyte, the first electrode comprising active materials such as a lithiated intercalation compound serving as the positive electrode or cathode and the second electrode comprising a carbon-carbon composite material and serving as the negative electrode or anode. However, the electrodes, taught by the aforementioned patents, are fabricated by machine working, which is expensive, requires specific machinery, and results in carbonic cells of large size (1-100 μm) thereby lowering the efficiency of the application of the materials at large current densities.

Alluding to the above, the cost reduction at the expense of elimination of machine working can be reached by the usage of the methods of a deposition of carbon from the vapor phase on the metallic substrate (current collector) by the method of plasma sputtering or different kinds of a chemical deposition from the vapor phase, and also by electron-beam vaporization. The shortcomings of the aforementioned methods presents a low speed of the material deposition (10-1000 um/hour) and low adhesion of the rather thick (more than 10 um) films to the current collector.

These aforementioned prior art methods share at least one disadvantage such as the active layer formed on top of the metal current collector of the electrodes to define a space therebetween, which negatively impacts specific power and energy, cycleability and possibility to properly function in applications requiring higher C-rate. The aforementioned methods negatively impact both the life span of the battery and the manufacturing costs associates therewith is the structure of the battery wherein the active layer is formed on the metal current collector and additional binders used as adhesion between the active layer and the metal current collector thereby increasing both the weight and size of the battery, which, as mentioned above, negatively impacts both the impedance characteristics of the battery and the manufacturing costs associated therewith.

But even with the aforementioned technique, to the extent it is effective in some respect, there is always a need for an improved processes for engineering of porous electrodes that is light, thin, cost effective, have improved life-span and ability to properly function in applications that depend upon higher C-rate and easy to manufacture.

### SUMMARY OF THE INVENTION

A metal current collector of the present invention is formed from a metallic tape used to form a first electrode such as an anode and a second electrode such as cathode combined into a cell for producing electric power without limiting the scope of the present invention. The metal current collector of the first electrode and the second electrode has opposed sides. An active layer is formed on the metal current collector. The active layer is formed from a plurality of granules fusible connected to the metal current collector. The granule presents a circular configuration having a size 2-15 μm.

A plurality of rods are integral with each of the granules extending outwardly therefrom in a first direction outwardly from the metal current collector. Each rod presents a circular cross-section and a diameter of at least 250 and up to 2000 nm. The length of the rod is at least 1.5 and up to 5.0 times longer than the diameter of the rod. A plurality of fibers are integral with and extending from each rod in a second direction generally perpendicular to the first direction of the rods. Each fiber presents a circular cross section includes a diameter of at least 5 nm and up to 100 nm and the length of said fiber is at least 1.2 and up to 15.0 times longer than the diameter of the fiber. The fibers have a laminar constitution with predominant orientation of lamellas perpendicularly to the axis of the fiber and have a spiral morphology. The fibers extending from each rod are fusible connected to one another thereby forming a porous structure of the active layer. The rods and the fibers form a grid of a three dimensional configuration to define pores therebetween thereby forming the porosity of the active layer ranging from 0% at the metal current collector to up to 80% as said active layer extends further away from said metal current collector.

The method of fabricating the aforementioned electrodes is also provided. The method includes the steps of moving the metal tape of at least one of the first and second electrodes followed by forming an aerosol drops from liquid carbonic material under pressure and partially solidifying the aerosol drops by forming of a crust surrounding a liquid core of each aerosol drop. The method also includes the step of forming the aforementioned active layer of the metal tape of at least one of the first and second electrodes with the active layer having a plurality of at least two elements, such as the rods and fibers being integral with and extending outwardly from one another in different directions received in response to boiling of the liquid core inside the crust and solidification of the liquid core boiled out of the crust.

The present invention concept is applicable to a carbon based nano-structural electrode used as an anode for lithium ionic batteries of high power, thereby ensuring steady cycling at currents of charge-discharge not less 100-300 C. The electrode does not contain organic dielectric binder and includes not less than three types of structural elements of the various sizes and forms (shapes), which form the aforementioned continuous grid and strongly bound with the metallic current collector. An inventive apparatus used to form the aforementioned inventive electrode forms the active layer by application aerosolic vapor-liquid mixture, in which before a deposition on the metal current collector, i.e. a substrate, the processes of crystallization, boiling and sublimation takes place, thereby forming electrodes with a deposition rate of the substance up to 50 μm per sec with the coefficient of its usage not less than 50-70%.

The inventive nano-structured and carbon based electrode presents improved adhesive bonding with the metal current collector and has a low electric resistance and a high thermal stability. The inventive structure of the aforementioned electrode provides a reliable cycling mode of the lithium-ionic batteries at the speeds of a charge and discharge up to about 300 C.

The inventive method is advantageously distinguished from the prior art methods and devices by the fact that the solid micro-particles of carbon received in the discharge gap between the carbon electrodes are melted and transferred by the way of vapor-liquid aerosol mixture to the side of the substrate. The inventive process of formation of the active layer on the substrate, i.e. the metal current collector is received by crystallization, boiling and sublimation of carbon resulting in high efficiency of the material deposition (up to 50 μm/sec) and high coefficient of the material usage of the electrodes production (not less than 50-70%).

Another advantage of the present invention is to provide a unique metal current collector of an electrode with integrated active core having a porous structure received by effective deposition of a material onto the metal current collector substrate in a binder free fashion while maintaining outstanding adhesion properties.

Still another advantage of the present invention is to provide a unique method for fabricating the electrodes wherein the metal current collector presents nano-structured surface at low cost.

Still another advantage of the present invention is to provide an electrode material having an improved nano-structure which is utilized as at least cathode or anode of a fuel cell leading to low thermal stability and improved live-span.

Still another advantage of the present invention is to provide high-performance equipment and methodology for high speed deposition of the particle of the active material while suppressing possible thermo-chemical degradation.

Still another advantage of the present invention is to provide cost effective and time effective high-performance mode of production of the electrodes which is based on porous structure of a current collector surface of the electrode.

Still another advantage of the present invention is to provide method of electrodes production for super condensers, fuel elements, electronic devices, in which the active materials present carbonic films of high through porosity, large specific surface of division, by thermal stability, by the adhesion to metallic and ceramic substrates (current collectors).

The present inventive concept has various applications including and not limited to high efficiency thin-film photovoltaic solar cells for cost-effective renewable energy, fuel cell components such as catalytic membranes for environmentally friendly power supplies, super capacitors for smaller and lighter portable handheld devices such as cell phones, laptops, thin film sensors for more effective monitoring and control of temperature, illumination, and humidity, high-conductivity wires with low resistance adaptable for manufacturing of a wide variety of electronic devices, and the like.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective fragmental view of a structure of a carbonic electrode of the present invention formed on a metal current collector wherein the structure is represented by a multitude of granules adhered to the metal current collector and having a plurality of rods homogeneously extending from the granules and a plurality of fibers extending from each rod with each fibers of each rod being fusibly connected with multiple fibers of the other rods thereby forming a grid of the metal current collector;

FIG. 2 illustrates various stages of formation of the grid showing transformation of an aerosol drop as the drop is fused with the metal current collector in a shape of the granule and formation of the rods and the fibers extending from the granule;

FIG. 3A is a general view of an inventive apparatus for forming the metal current collector of FIGS. 1 and 2;

FIG. 3B is a schematic view of the apparatus of FIG. 3A;

FIG. 4A illustrates the parameters of carbonic granules obtaining by one of the modes of the present invention;

FIG. 4B illustrates the structure of the carbonic granules, obtained by the one of the modes of the present invention;

FIG. 4C illustrates structure of the carbonic granules, obtained by the one of the modes of the present invention;

FIG. 4D is illustrates structure of the carbonic granules, obtained by the one of the modes of the present invention;

FIG. 5A illustrates the electrode obtaining by the mode of the present invention;

FIG. 5B is demonstrate results of XRD analysis of the electrode, obtained by the another mode of the present invention;

FIGS. 6A through 6D illustrate various views of the electrode structure obtained by another mode of the present invention;

FIGS. 7A through FIG. 7D illustrate various views of a fine electrode structure obtained by another mode of the present invention;

FIGS. 8A through 8B are illustrations of the structure of the metal-carbonic composite electrode obtained by the still another mode;

FIGS. 9A through 9C are illustrations of the structure of the electrode, obtained by the still another mode of the present invention after the tests on the adhesive strength;

FIGS. 10A and 10B are illustrations of the electrode structure, obtained by the still another mode of the under the conditions of heightened pressure; and

FIGS. 11A and FIG. 11B are illustrations of the results of electrochemical tests of the electrodes according to one of the examples of the present invention obtained by the various modes of the present invention.

### DETAILED DESCRIPTION OF THE PREFERRED EMBODIMENT

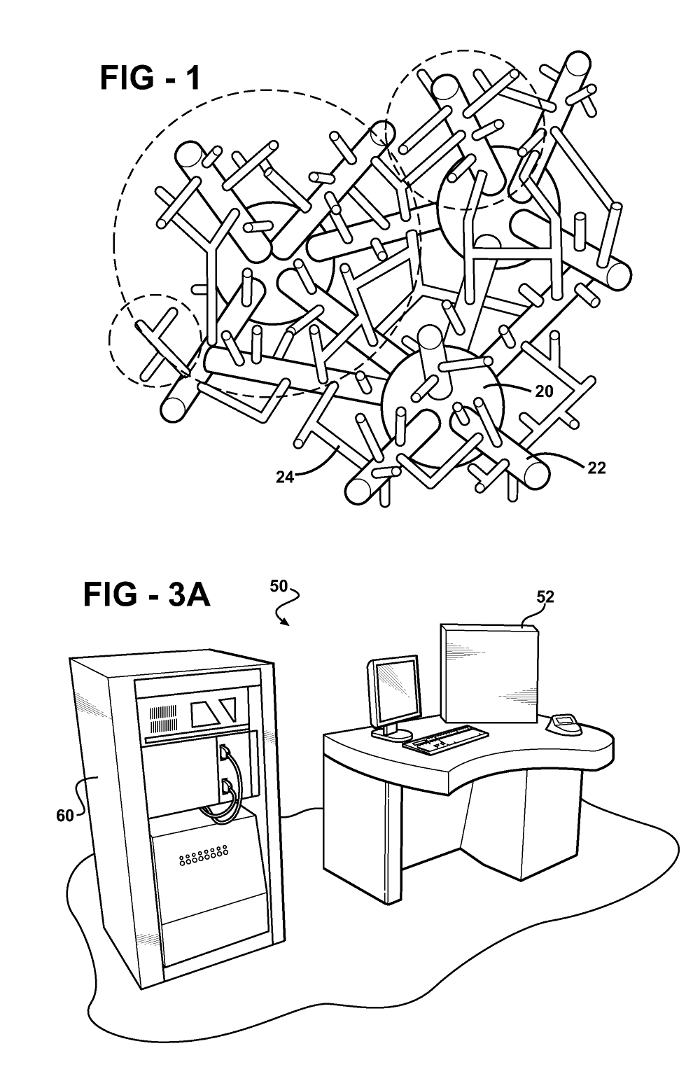

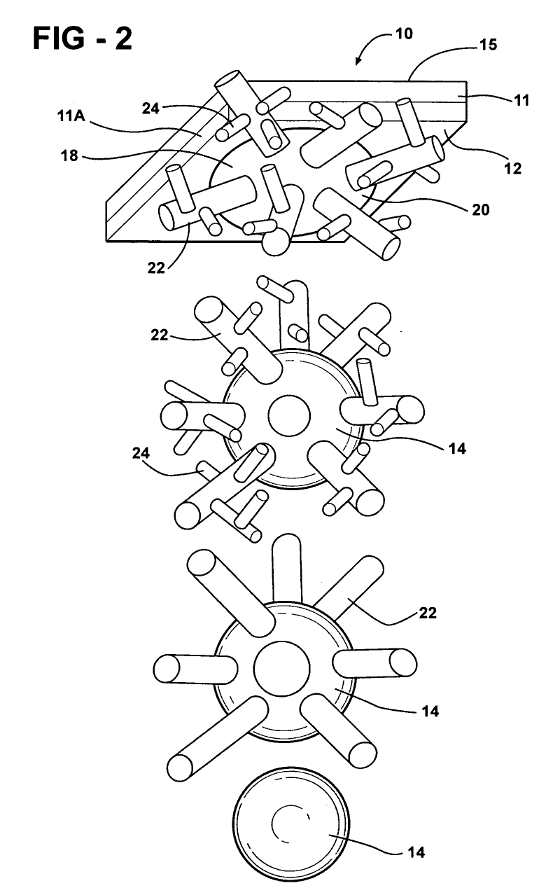

Referring to the Figures, wherein like numerals indicate like or corresponding parts, an electrode of the present invention is generally shown at 10. The electrode 10 of the present invention is formed from a metal tape, i.e. foil, generally indicated at 11 and shown fragmentally in FIGS. 1 and 2, is used to form a first electrode such as an anode and a second electrode such as cathode (both not shown), spaced by a separator and combined into a cell (not shown) for producing electric power without limiting the scope of the present invention. The metal current collector or substrate 11 of the first electrode and the second electrode has opposed sides 12 and 14, as best illustrated in a cross sectional view shown in FIGS. 1 and 2.

The electrodes are combined into at least one cell used for a battery (not shown) for an automotive vehicle (not shown). The present inventive concept has various other applications including and not limited to high efficiency thin-film photovoltaic solar cells for cost-effective renewable energy, fuel cell components such as catalytic membranes for environmentally friendly power supplies, super capacitors for smaller and lighter portable handheld devices such as cell phones, laptops, thin film sensors for more effective monitoring and control of temperature, illumination, and humidity, high-conductivity wires with low resistance adaptable for manufacturing of a wide variety of electronic devices, and the like (all not shown). Preferably, the present invention is applicable to a carbon based nano structural electrode used as an anode for lithium ionic batteries of high power, thereby ensuring steady cycling at currents of charge-discharge not less 100-300 C. The electrode 10 of the present invention is free from organic dielectric binder of any kind and includes at least three types of structural elements of the various sizes and forms (shapes), which form the aforementioned continuous grid and strongly bound with the metallic current collector.

Alluding to the above, an active layer, generally indicated at 18 in FIGS. 1 and 2, is formed on the metal current collector 11. Alternatively, the active layer 18 may be formed inside the metal current collector 11 (not shown). The active layer 18 is formed from a plurality of granules 20 fusible connected to the metal current collector 11. The granule 20 presents a circular configuration having a size 2-15 μm. The size of the granules is not intended to limit the scope of the present invention and is presented herewith for exemplary purposes. A plurality of rods 22 are integral with each of the granules 20 extending outwardly therefrom in a first direction outwardly from the metal current collector 11. Each rod 22 presents a circular cross-section and a diameter of at least 250 and up to 2000 nm. The length of the rod is at least 1.5 and up to 5.0 times longer than the diameter of the rod. The size, diameter, and the length of the rods 22 are not intended to limit the scope of the present invention and are presented herewith for exemplary purposes. Alternatively, the rods 22 may present rectangular or elliptical cross section without limiting the scope of the present invention.

A plurality of fibers 24 are integral with and extending from each rod 22 in a second direction generally perpendicular to the first direction of the rods 22. Each fiber 24 presents a circular cross section and includes a diameter of at least 5 nm and up to 100 nm and the length of the fiber 22 is at least 1.2 and up to 15.0 times longer than the diameter of the fiber 24. The fibers 24 have a laminar constitution with predominant orientation of lamellas perpendicularly to the axis of the fiber 24 and have a spiral morphology. The fibers 24 extending from each rod 22 are fusible connected to one another thereby forming a porous structure of the active layer 18. The rods 22 and the fibers 24 form a grid of a three dimensional configuration to define pores, as best illustrated in FIG. 1, thereby forming the porosity of the active layer ranging from 0% at the metal current collector to up to 80% as said active layer extends further away from the metal current collector 11. The size, diameter, and the length of the fibers 24 are not intended to limit the scope of the present invention and is presented herewith for exemplary purposes. Alternatively, the fibers 24 may present rectangular or elliptical cross section without limiting the scope of the present invention.

Alluding to the above, the unique layout and connection of the rods 22 and the fibers 24 of the metal current collector 11 positively affects on the characteristics of the capacity and cycling ability of the cell. The nano structure of the active layer 18 allows to facilitate a high speeds of a charge and discharge of the cell. At least one of the nano structural elements such as, the granules 20, the rods 22, and the fibers 24 are scaled in such a way which permits to supply 100% usage of an active substance (material) in the electrochemical process as the cell is used in various applications. At the same time, at least one of the nano structural elements such as, the granules 20, the rods 22, and the fibers 24 accumulates and/or effectively removes electrons, which are formed as a result of intercollation of lithium, thereby resulting in a high capacity value at a small impedance of the electrode. At least one of the nano structural elements such as, the granules 20, the rods 22, and the fibers 24 have a diffusive contact with one another and are submitted (represented) by crystalline carbon with the lamellar constitution. Thus, the structure of the electrode presents a continuous grid, whereby the granules 20, the rods 22, and the fibers 24 contact the metal current collector 11. The structural elements such as the granules 20, the rods 22, and the fibers 24 of multi dimensional configuration are placed perpendicularly to one another to derivate a continuous grid damping deformation of the fibers 24. It provides a high cycling of the electrodes at high currents of a charge and discharge. At least one of the granules 20, the rods 22, and the fibers 24 presents a spiral-shaped configuration, wherein the Burgers vector of which is directed to the side of the fiber growth. The presence of spiral dislocations provides higher strength of the fiber 24, which makes the electrode being more stable to volumetric changes at cycling. The granules 20, the rods 22, and the fibers 24 are fusibly connected to one another thereby reducing the electrical resistance of the carbon. The nano-structural elements of the electrode are submitted by graphite, predominantly 3R modification, thereby providing improved intercollation of lithium into the crystal lattice of graphite. As such the resistance of electrochemical reaction of intercollation is decreased, thereby increasing of operating currents of the element. The structure of the electrode can have a through porosity, changeable along the cross-section of the active layer 18. Thus, the most dense layers are generally adjacent the metal current collector 11. Such layout reduces the resistance between the active substance and the surface of the metal current collector and increases the adhesion of an active material onto the metal current collector 11. On the surface of the fibers 24 and the rods 22 the globular inclusions of metals can be disposed in the absence of their chemical interaction with carbon. The fibers 24 and the rods 22 improve general electro-conductivity of the electrode and in some cases, such as, for example, the fuel cell applications, thereby rendering a catalytic action. Moreover metals and alloys can also be an active substance of the electrode and increase its capacity.

As best illustrated in FIG. 2, the electrode having the inventive active layer 18 begins with formation of an aerosol from the drops 30 of liquid carbon with diameter 1-10 μm in previously pumped out volume up to residual pressure less than 10⁻⁶ TORR followed by vaporization of carbon in the area of aerosol sputtering with the formation of the vapor-liquid aerosol mixture. The drop 30 is directed through the vapor-liquid aerosol application to the side of the metal current collector 11 thereby resulting in creation of the conditions between a source of a vapor-liquid aerosol and the metal current collector 11, which ensures the implementation of partial solidification of a liquid aerosol phase with formation of firm crust and liquid core in each separate drop of an aerosol (solid-liquid fragments). Sublimation of carbon from a vapor phase onto the surface of the hardened crust in the form of the nano structural fibers 24 or rods 22 is followed by deposition of the mixture having solid-liquid fragments onto the metal current collector 11, followed by solidification of the same resulting in continuing sublimation from the vapor phase. The aerosolic vapor-liquid mixture that includes drops 14 of the liquid carbon and a non-saturated carbonic vapor is directed to the side 12 of the substrate 11. Between the source of an aerosolic mixture and the substrate 11 the solid-liquid fragments are formed from the aerosolic drops. The liquid core is boiled under the solid crust thereby destroying the solid crust with the formation of a scaly relief resulting in response to the pressure drop as the liquid-solid particles move to and impact with the substrate 11. The destruction of the solid crust and penetration of the liquid phase onto its surface is also promoted by volumetric effects, bound with solidification shrinkage. The boiling liquid effect results in formation of the granules 20 on the side 12 of the metal current collector 11 wherein the granules 20 do solidify. Some quantity of carbon can remain in a liquid state thereby resulting in formation of the rods 22. The density of the vapor phase reaches the value of a saturation, indispensable for implementation of the sublimation of carbon onto the surface of the solid fragments. The sublimation of carbon (formation of a solid phase from a supersaturated vapor phase) results in the formation of the fibrous carbon with a round or rectangular cross-section, such as the fibers 24.

When reaching the substrate 11, the solid-liquid fragments, which include the granules 20, the rods 22, and the fibers 24, finally solidify in the conditions of the continuing sublimation of carbon. The negative influence of shrinkage phenomena at the crystallization of carbon is indemnified by its sublimation deposition. The above-stated processes are carried out within a short period of time in the conditions, which are greatly distinguished from the equilibrium ones. Therefore the thermodynamic parameters of a melting, boiling, sublimation and solidification of carbon were selected empirically, but not on the basis of the existing phase constitutional diagram of carbon. The suggested method of obtaining of carbonic electrodes presents a high speed of a deposition of the material (up to 50 μm/sec) and high coefficient of the material application. Numerous materials such as carbon or graphite can be utilized, since their vacuum vaporization renders a refining effect.

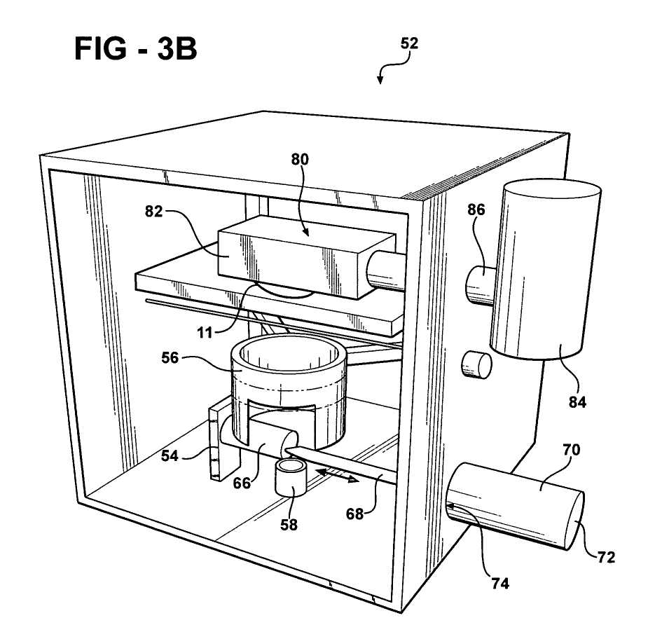

FIG. 3A illustrates an apparatus of the present invention, generally shown at 50. The apparatus includes a chamber, generally shown at 52 in FIGS. 3A and 3B. The chamber 52 is pressurized to the residual pressure less than 10″⁶ TORR. An evaporator defined by an arc-device 54 is disposed in the chamber 52. The evaporator 54 presents as a source of the aerosolic vapor-liquid mixture. A multi-sectional furnace 56 is placed between the evaporator 54 and the substrate 11. The furnace 56 ensures a temperature gradient in the direction from the evaporator 54 to the substrate 11. The apparatus 50 further includes a device 58 for facilitating a predominant motion of a vapor-liquid aerosol mixture towards the side 12 of the substrate 11. A system 60 of the fixing and control of the parameters of vaporization and deposition of the material is also provided by the apparatus 50. The device 58 includes an evacuated chamber 62, pumped out up to residual pressure 10⁻⁶ TORR with the help of rotator and vapor-oil pumps.

The arc sputtering device 54 includes coaxially arranged carbonic rods 66 and 68. One of the rods 66 is fixed, and the other rod 68 produces longitudinal motions (shown by an arrow) into the side of the fixed rod 66. the rod 68 is axially movable relative the rod 66. The rods 66 and 68 may present identical of various diameters without limiting the scope of the present invention. The rods 66 and 68 do not contact each other. As the rod 68 approaches the other rod 66 an arc charge results in response thereto, which results in vapor of carbon atoms which later results in formation of the aerosol drops 14. An electromechanical driving mechanism 70 moves the rod 68. The electromechanical driving mechanism 70 includes a stepping motor 72 and a worm-and-wheel gearbox 74. The stepping motor 72 is also used with an electromagnetic low frequency vibrator 76.

A cooling system, generally indicated at 80, is disposed inside the chamber 52. The cooling system 80 includes a heating element 82 positioned adjacent the metal current collector 11. The heating element 82 is rotatable with the metal current collector 11 during the formation stages of the active layer 18. A reservoir 84 is connected to the wall of the chamber 52. The reservoir 84 holds nitrogen. A tube 86 connects the reservoir 84 with the heating element 82 for delivering nitrogen thereto. The cooling system 80 is used to maintain the temperature of the metal current collector 11 as the active layer 18 is formed.

A controller (not shown) is operably communicated with the stepping motor 72 to manipulate and control the reciprocating and translational motion of the rod 68. The controller operably communicates with the arc sputtering device 54 thereby manipulating a cyclical mode in a discharge gap during mechanical local destruction of the electrodes as the same contacts with the formation of the firm microparticles and the obtaining of the ionized carbonic vapor, fusion of the fragments with the formation of aerosolic vapor-liquid mixture, the increase of an interspace between the rods 22 before the termination of the discharge. In some cases the electrode 68 is connected with a piezo-electric or other ultrasonic converter (not shown), working within the range 22-45 KHz. The cavitation boiling of the liquid phase in a discharge gap increases the efficiency of the aerosol formation.

Alternatively, additional arc sputtering device and additional source of vapor is provided wherein the rods 66 and 68 commit only a translational motion. An additional evaporator increases the density of the carbonic vapor in the vapor-liquid aerosolic mixture. Additional unit included a pressure-tight chamber which is joined in the top with an evacuated volume. A gradient furnace is located inside the chamber coaxially to the chamber axis. The gradient furnace includes several heating sections. The established temperature of the heaters controls a negative temperature gradient in the direction from the evaporator to the substrate 11. Preferably, the gradient furnace 58 includes three sections and provides a negative temperature gradient in the direction from the evaporator up to the substrate not less than 60 K/cm upon the temperature of the lower section 800-1400° C. Upon formation of an aerosol in a discharge gap the pressure in the lower part of the considered chamber increases, and the aerosolic mixture advances upwardly, and appears in the zone of the gradient furnace operation.

As the temperature of the lower section of the furnace is increased relative to the temperature of the upper section, the aerosolic mixture gains an additional acceleration and proceeds onto the substrate 11. Besides, the temperature gradient in the furnace provides the implementation of cooling of the aerosol liquid drops from their surface and formation of the firm crust of carbon, boiling of the liquid carbon inside the crust of the aerosol drop resulting in the change of morphology of the surface, and sublimation of carbon on the surface of the solid fragments such as the rods 22 and the fibers 24.

Alluding to the above, the implementation of the aforementioned process promotes a decrease a vapor pressure in the direction from the evaporator to the substrate 11. Due to high speed of the aerosol drops, the temperature of the liquid core of the drops varies, the release of the pressure results in the boiling of the liquid carbon core. Moreover, the density the carbonic vapor reaches the value of saturation, sufficient for its sublimation in the form of the carbonic fibers 24 on the surface of the solid fragments. The overall performance effectiveness of the aforementioned device is improved with the help of the diaphragm and a source of inert gas, such as helium or the like, having the temperature of 1000-1200° C., which allows to create in the low part of the evaporator the partial pressure of 10⁻³-10⁻¹ TORR. Thus, the speed of the motion of the aerosol to the substrate 11 is essentially increased and the stability of the arc operation is raised. The increase of efficiency of carbon precipitation process can also be reached by enclosing of a negative potential to the substrate 11 or due to the additional energetic influence by a high frequency field. Alternatively, the substrate 11 may be formed from ceramic material. The substrate 11, both ceramic and non ceramic may be rotated to increase the uniformity along the thickness of the active layer 18 with the frequency of 1 s⁻¹ and more thereby establishing the temperature of the substrate 11 is within the range of −70-300° C. to provide the best adhesion between the rods 22 and fibers 24.

The apparatus 50 includes a systems of assignment and control of following main specifications of sputtering and deposition of the substance that include and are not limited to arc current in a discharge gap, the electrode separation distance, speed and direction of their motion, the temperature gradient in the direction from the evaporator up to the substrate, the temperature of the substrate, the vapor density and the size of the drops the substrate 11, the residual pressure nearby to the evaporator and substrate 11. As the interval of thermodynamic parameters of synthesis of the structure of the electrode due to the given way is narrow, and deposition rate of the material onto the substrate 11 is high, the process of the formation of electrode is fully automated by the creation of feedbacks from monitoring sensors (not shown) to the execution units. For example, the size and bulk density of solid-liquid carbon particles near to the substrate 11 is determined by a laser (not shown), working in the regime of a stroboscoping and a photodetector (both not shown). As the photodetector conforms the excess of the size of the drops 14 of the desired value (2-15 μm) automatically decreases the time of contact of the carbonic rods 22 and increases the electric voltage between them. The apparatus 50 allows within the wide range to change a ratio between the volume rations of the rods 22, the fibers 24, and the granules 20.

The size and bulk density of the granules 20 is determined mainly with the electric voltage between the carbon rods 22 the discharge current. The size and degree of a bifurcation of the structural elements of the rods 22 is adjusted by the temperature gradient along the axis of the sectional furnace and by the values of the temperature of the lower section. The temperature gradient reduction and the temperature rise of the lower section results in the curtailment of the quantity and the decreasing of the sizes of the elements of the rods 22. The morphology, size and quantity of the fibers 24 is regulated by the vaporization rate between the carbonic rods 22 and value of a gradient of temperature in the sectional furnace. With the increase of these parameters the quantity of the fibers 24 is increased. The relation of the length to the diameter of the fibers 24 is also increases.

The apparatus 50 is adaptable to receive the fibers 24 in the helical (spiral) shape. In this case the speed of back-and-forth motion of the carbonic rods 22 is slowed down at the stage of their dilution. It increases the duration of process of a sublimation of carbon onto the rods 22 and stimulates the formation of the fibers 24 due to the mechanism of the helical dislocation development. The apparatus 50 is also designed to receive an additional evaporator established in an internal volume of the upper section of the gradient furnace coaxially to its axis. The parameters of vaporization of metal are established as such, that it deposits on a carbonic substrate in the form of granules with the size 2-40 nm. The indicated granules are used for the increasing of the capacity and electrical conductivity of anodic electrodes of lithium of ionic batteries or as catalysts of electrochemical reaction in the fuel cells.

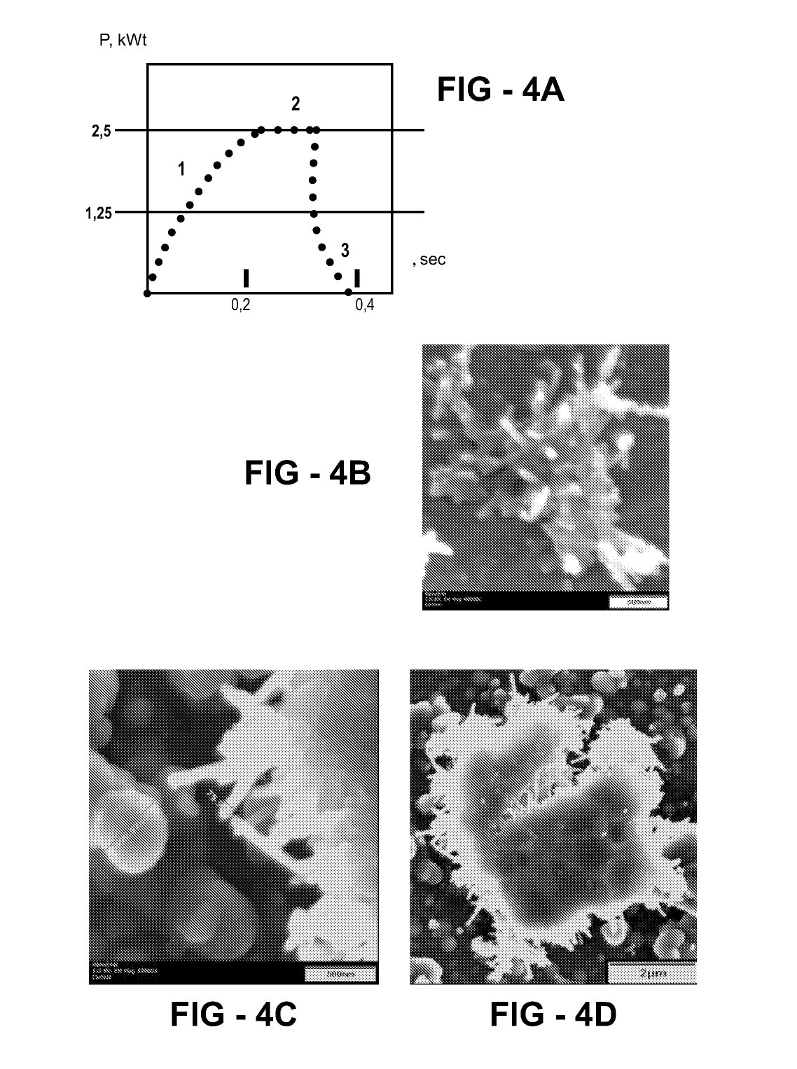

Alluding to the above, the several alternative embodiments of the inventive method are described herebelow. The first of the alternative embodiments presents obtaining of the carbon based electrodes. The metal current collector and the carbonic rods are placed into the apparatus for obtaining the electrodes. A copper foil by thickness 40 μm is used as a substrate of the metal current collector for anodes of the lithium ionic batteries. The substrates presents the diameter of 20 mm. The carbonic rods have the diameter of 6 nm and have the grade EC02 and may be manufactured by GRAFI corporation. The aforementioned working chamber of the apparatus is pressured to a residual pressure 10⁻⁶ TORR. The DC voltage of up to 50 V is applied to the carbonic rods after the same brought together until the electric discharge occurred and then pulled apart. The rods 66 and 68 are moved in such a manner that the relation of power disseminated in a discharge gap from time corresponded to the schedule shown in FIG. 4A. In that case stages of local destruction of the rods, melting of fragments and formation a carbonic vapor are present. The obtained vapor-aerosolic mixture is directed to the three-section furnace. In the lower section of the furnace the temperature is 1200° C., in the middle section −820° C., in the upper part −440° C. The temperature of the substrate is −20° C. A carbonic layer is formed on the substrate. The carbonic layer includes the separately lying fragments, having the spherical form and high highly adhered to the substrate. The surface of the fragments is coated with the fibers of nano structural carbon, as shown in FIG. 4B. The carbonic layer is fixed with the help of the binding on the basis of the epoxy tar, and its cross section is formed by application of the device, such as ULTRAMICROTOM, that includes a diamond knife, used for preparation of the objects for electronic-microscopic examination. The obtained shears are subjected to the analysis by the scanning electron microscope, as shown in FIGS. 4C and 4D. The granules present have the size 6-8 μm, the rods have the size 250-2000 nm and are coated by nano fibers having the diameter 5-100 nm. The rods and fibers are placed predominantly perpendicularly to one another.

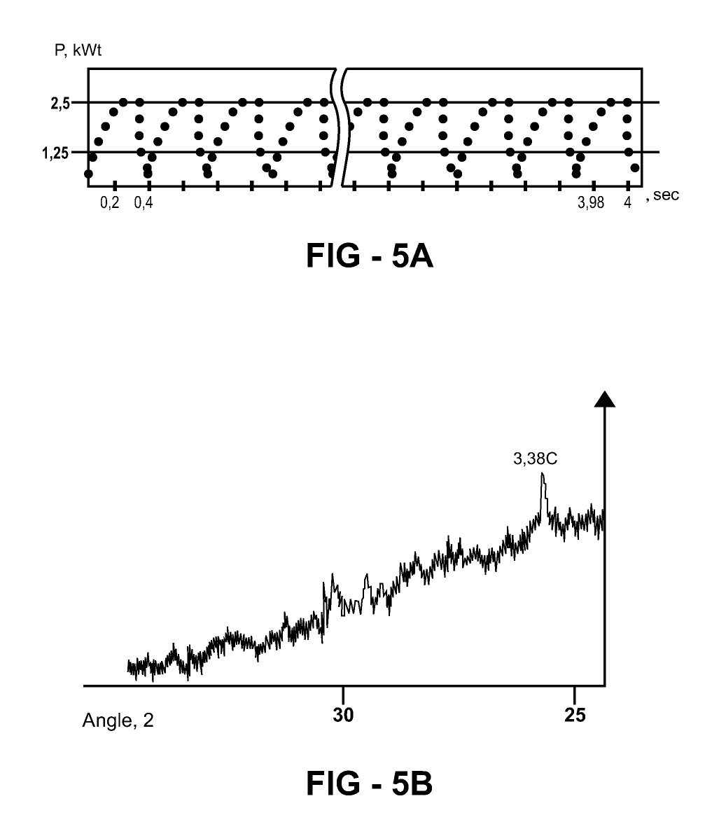

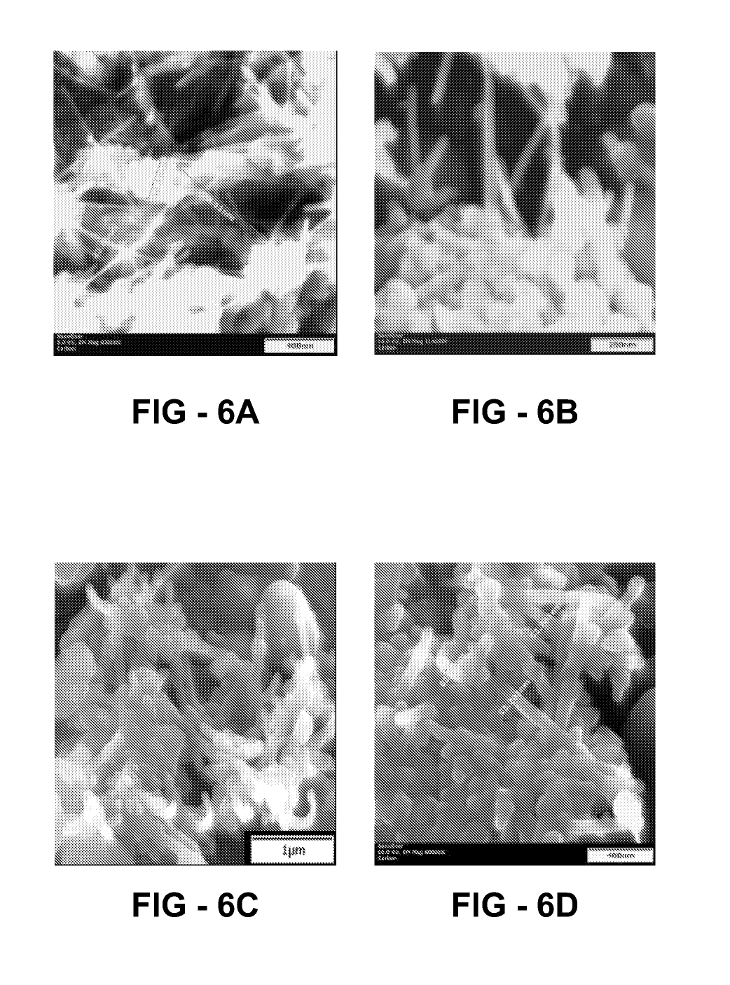

Referring to FIG. 5A, the nature of motion of rods was established in a way wherein the dependence of power, released in a discharge gap. By this method the electrode with area density of carbon 1.1 mg/cm² and thickness of its layer 92-100 urn was obtained. The carbon deposition time made up 4 sec, that corresponded to productivity up to 25 μm/sec. The coefficient of the material usage, determined as the relation of weight of carbon deposited on the substrate to the weight loss of carbon rods made up 0.55. The thickness of the electrode was determined with the help of an optical depth gauge, which was focalized first on the substrate, and then on the surface of the carbonic layer. The XRD analysis executed in Co monochromatic radiation, as illustrated in FIG. 5B illustrates the presence of 3R and 2H graphite with a high extent of a crystallinity. The test conducted by a scanning electron microscopy, as shown in FIG. 6, demonstrated that the electrode structure represents the alternation of spherelitic carbon fragments with a branched surface by the size 2-15 μm and has a diffuse contact with one another in the continuous grid.

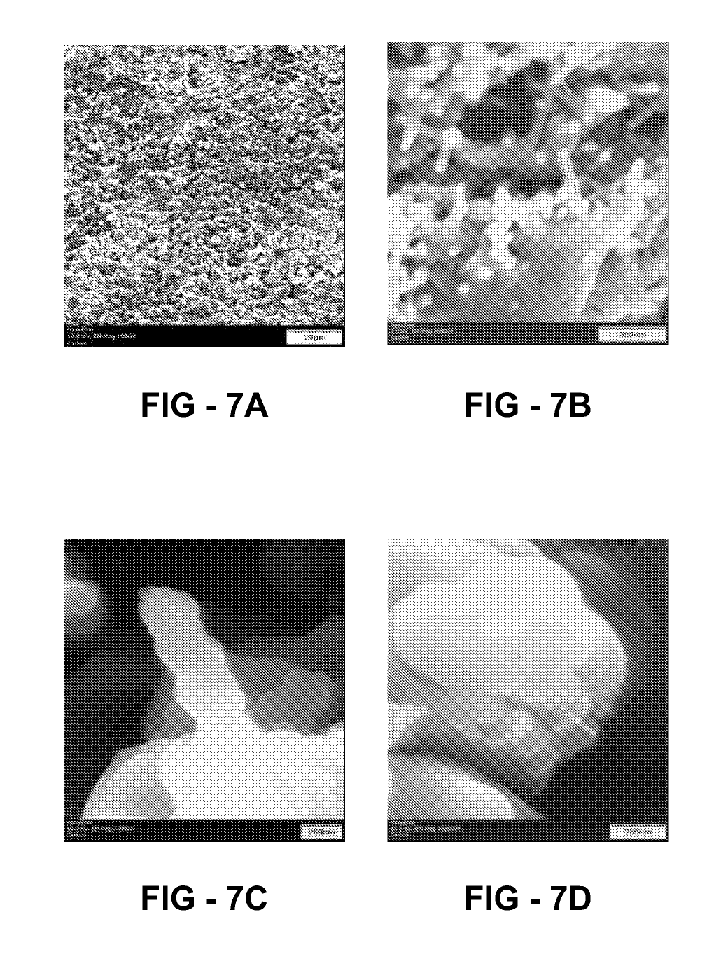

FIG. 6B illustrates the coalescence of carbonic fibers, belonging to the adjacent granules. FIGS. 6C and 6D demonstrate a thin constitution of separate granules. As it is visible, the granules having the rods of the rounded or rectangular section, having the diameter or a diagonal of the cross section 250-2000 nm and the length by 1.5-5.0 times exceeding the size of the cross section. The carbonic fibers of the round or rectangular section with the diagonal or diagonal of cross section 5-100 nm and length by 1.2-15.0 times exceed the above-stated size of the cross section. The rods and fibers are located perpendicularly to one another. Several granules may include the fibers of different diameters, growing perpendicularly to one another and generating a continuous grid as well. The low magnification view, as shown in FIG. 7A, shows an improved structure homogeneity of the electrode. In some cases the structure elements of the fibers forms perpendicular to each other fragments, as shown in FIG. 7B. The research of the fibers and rods upon large increases, as shown in FIGS. 7C and 7D demonstrates that they have a laminar or helical constitution. During the deposition process of a carbonic layer due to one of the modes of the present invention, the vapor of metal was added into the overcooled carbonic vapor. The vaporization of metal made with the help of the separate thermal evaporator of a ring-type type established in the upper section of the gradient furnace. The vaporization of metal was implemented through a screen filter, having the temperature higher than the temperature of vaporization of metal. The ring-type evaporator had a special screen protection for an avoidance of its influencing on formations of carbonic fragments of indispensable morphology. The consumption of metal in the process of vaporization was controlled with the help of a metering device of an auger type. The used metals were argentum and bismuth. Upon the metal spraying the temperature of the upper section of gradient furnace was lowered up to 300° C. In these conditions the metal deposited onto the surface of the firm carbon by the way of globular actuations with the size 2-40 nm.

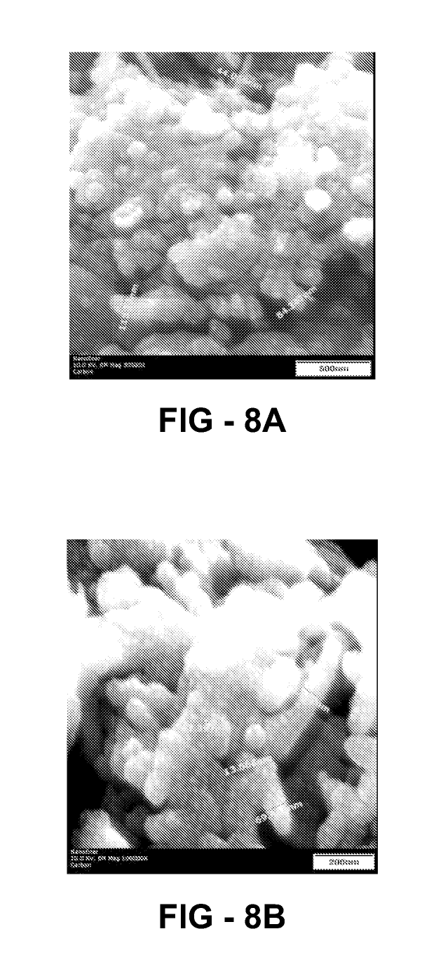

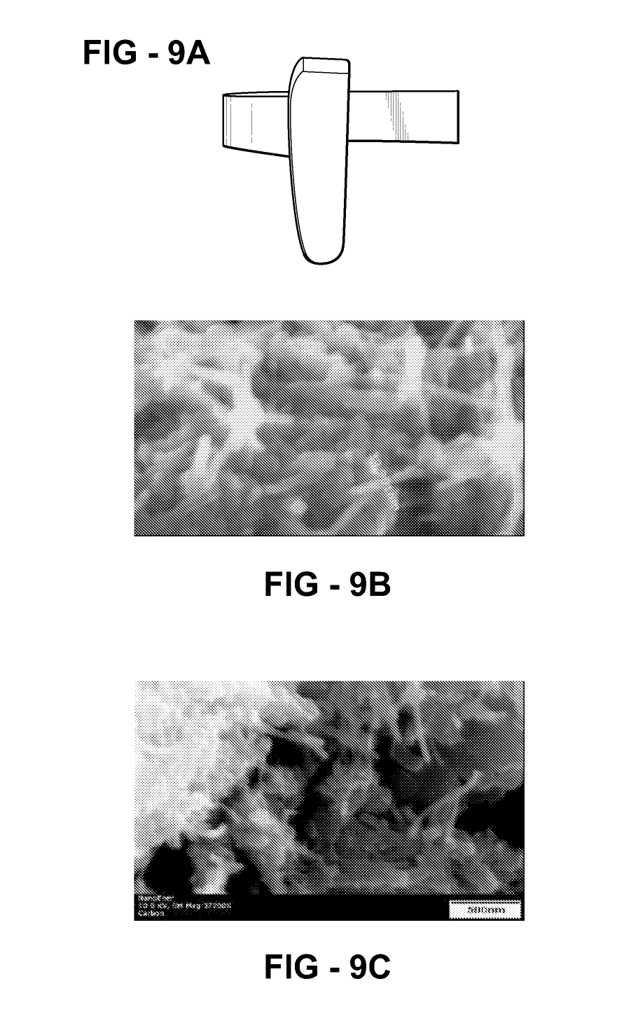

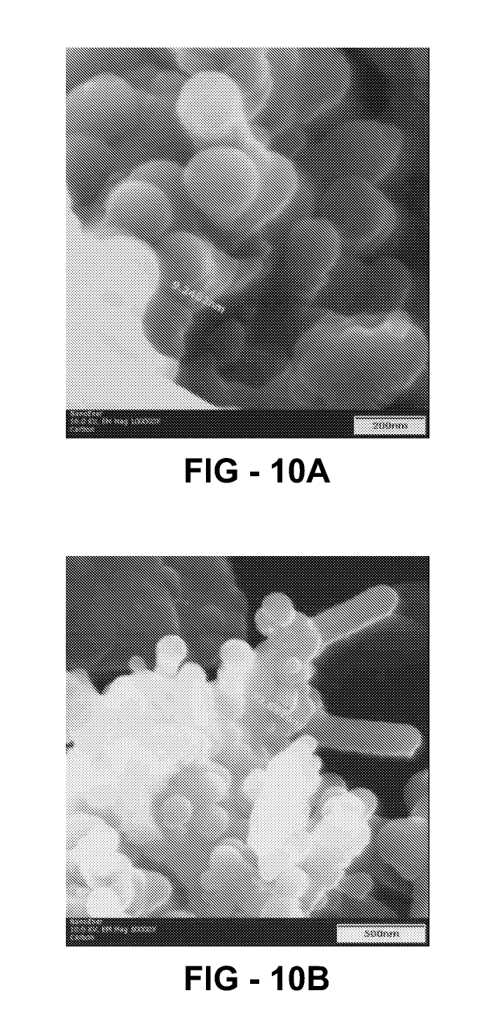

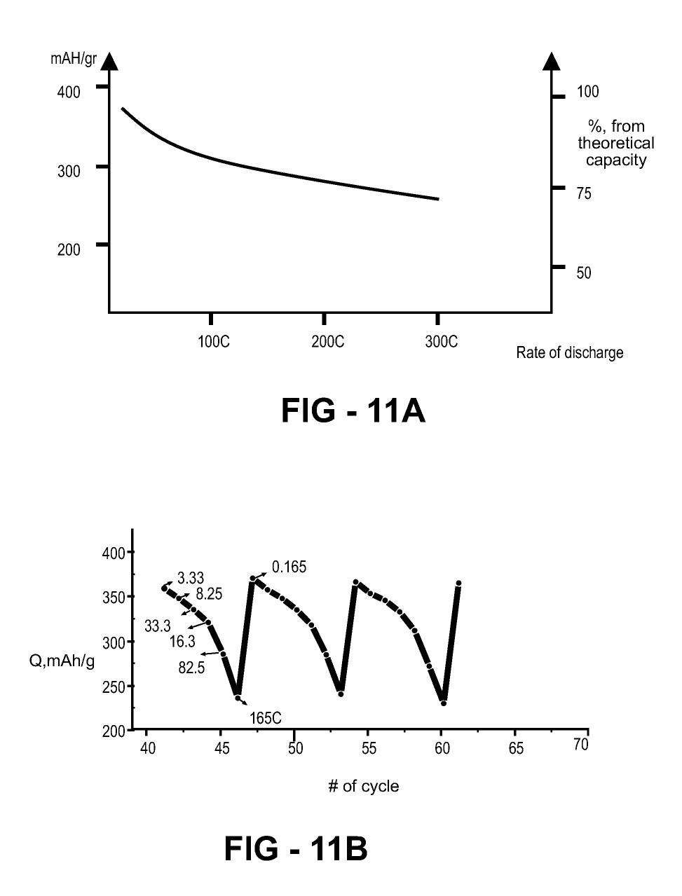

FIG. 8 shows the globular inclusions having a large part of the surface of carbon being exposed. The tests on compression were conducted with usage of the attachment to a scanning electron microscope JSM-35 (JEOL). The sample of the electrode by the size 10×10 mm was attached in the holder of the compressing device on a holder-adapter with the diameter of 0.8 mm and was curved with a running speed of a plunger of 1 mm/minute. Simultaneously with it the surface of the electrode was kept under the control and at the moment of occurrence of the first maiden cracks or delamination the bending process was intercepted, and the maximum bend angle of a sample was fixed. The measurements have shown, that these electrodes maintain a bending 150-170 grades without any destruction or delamination of a carbonic layer. As it is evident from the aforementioned data shown in FIG. 9A, the destruction of the carbonic layer at maximum bend angles take place according to the mechanism of the delamination of the carbonic fibers on the border of the contact of the granules. The data represented do testify about a high adhesion of a carbonic layer to the metallic substrate. In the given example the parameters of obtaining of the electrode according to one of the modes of the present method, however, in the field of formation of the vapor-liquid aerosol mixture there was an overpressure 10⁻² TORR. The heightened pressure was provided by the letting-to helium at the temperature of 1000° C. Thus the deposition rate of carbon up to 50 μm/sec and factor of its usage up to 75-80% thus were increased. The electron microscopic analysis shows that in this case the branching of the fibers and rods is less, than in the electrode, as shown in FIGS. 10A and 10B, wherein the electrode was tested in the capacity of anode for the lithium ionic cell. The electrode sample was placed opposite to Li metal electrode with the separator in-between and filled with standard Li-Ion electrolyte (LiPF6 in EC/DMC). The element was placed into the body of the standard coin size cell and tested in the galvanostatic regime at different discharge currents. The current of a charge of the cell corresponded to the discharge current. FIGS. 11A and 11B illustrates that the anodic electrode has excellent indexes of capacitance at currents of charge-discharge up to 300 C. In this case the system is cycled without the change of capacitance. The capacitance of a charge and discharge of the electrode is practically identical, that testifies the high stage of convertibility (reversibility) of the process cycling. The electrode obtained by the mode of another example has shown a smaller capacitance at high discharge currents (165 C), however as well as the previous one, the electrode has demonstrated an excellent reversible cycling. After the cycling at 165 C the electrode was tested at low (IC) discharge currents.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electrode for a cell for producing electric power comprising;
a substrate for collecting current, and
an active layer of said electrode defined by a plurality of first elements with each of said first elements presenting at least one second element being integral with each of said first elements extending outwardly therefrom in a first direction and at least one third element being integral with and extending from each second element in a second direction with said second and third elements being fusible connected to one another thereby forming a porous structure of said active layer.

2. An electrode as set forth in claim 1 wherein said second elements and said third elements form a grid of a three dimensional configuration to define pores between said second and third elements of said active layer of at least one of said first and second electrodes.

3. An electrode as set forth in claim 2 wherein said first elements present granules having at least one of circular and rectangular configuration and a size of 1-15 μm.

4. An electrode as set forth in claim 3 wherein said second element is further defined by a rod homogeneously extending from each granule.

5. An electrode as set forth in claim 4 wherein said rod present a rectangular cross-section.

6. An electrode as set forth in claim 4 wherein said rod presents a circular cross-section.

7. An electrode as set forth in claim 4 wherein said rod presents a diameter of at least 250 nm.

8. An electrode as set forth in claim 4 wherein said rod presents a diameter of up to 250 nm.

9. An electrode as set forth in claim 4 wherein said rod presents a diameter of up to 2000 nm.

10. An electrode as set forth in claim 4 wherein said third element is further defined by a fiber integral with and homogeneously extending from said rod in said second direction being generally perpendicular to said first direction of said rod with said fibers of one of said rods homogeneously connecting with said fibers of another rod thereby forming said porous structure of said active layer.

11. An electrode as set forth in claim 10 wherein said fibers and said rods are carbon fibers and carbon rods.

12. An electrode as set froth in claim 11 wherein said fiber presents a rectangular cross section.

13. An electrode as set forth in claim 11 wherein said fiber presents a circular cross section.

14. An electrode as set froth in claim 10 wherein said fiber includes a diameter of up to 100 mm.

15. An electrode as set forth in claim 10 wherein said fiber includes a diameter of at least 5 nm.

16. An electrode as set forth in claim 10 wherein said fiber includes a diameter of up to 5 nm.

17. An electrode as set forth in claim 10 wherein said fibers have a laminar constitution with predominant orientation of lamellas perpendicularly to the axis of said fiber.

18. An electrode as set forth in claim 17 wherein said fibers have a spiral morphology.

19. An electrode as set forth in claim 1 wherein said porosity of said active layer ranges from 0% at a metal tape for collecting current to up to 80% as said active layer extends further away from said metal tape.

20. An electrode as set forth in claim 9 wherein the length of said rod is at least 1.5 and up to 5.0 times longer than the diameter of said rod.

21. An electrode as set forth in claim 14 wherein the length of said fiber is at least 1.2 and up to 15.0 times longer than the diameter of said fiber.

22. A cell for producing electric power comprising;
a first electrode and a second electrode formed from a metal substrate for collecting current,
an electrolyte disposed between said first and second electrodes,
an active layer of at least one of said first and second electrodes defined by a plurality of granules fusible connected to said metal substrate, said granule presenting at least one of circular and rectangular configuration and a size of 1-15 μm,
at least one rod being integral with each of said granules extending outwardly therefrom in a first direction outwardly from said metal substrate wherein said rod presents a circular cross-section wherein said rod presents a diameter of at least 250 and up to 2000 nm and the length of said rod is at least 1.5 and up to 5.0 times longer than the diameter of said rod,
at least one fiber being integral with and extending from each rod in a second direction generally perpendicular to said first direction of said rods wherein said fiber presents a circular cross section wherein said fiber includes a diameter of at least 5 nm and up to 100 nm and the length of said fiber is at least 1.2 and up to 15.0 times longer than the diameter of said fiber,
said fibers have a laminar constitution with predominant orientation of lamellas perpendicularly to the axis of said fiber and having a spiral morphology, and
said fibers of each of said rods being fusible connected to one another thereby forming a porous structure of said active layer wherein said rods and said fibers form a grid of a three dimensional configuration to define pores therebetween thereby forming said porosity of said active layer ranging from 0% at a metal tape for collecting current to up to 80% as said active layer extends further away from said metal tape.

23. A method of forming at least one electrode for cell to collect electric current and an electrolyte disposed therebetween, said method comprising the steps of:
moving a metal tape of the electrodes;
forming an aerosol drops from liquid carbonic material under pressure;
partially solidifying the aerosol drops by forming of a crust surrounding a liquid core of each aerosol drop; and
forming an active layer of the metal tape of the electrode with the active layer having a plurality of at least two elements being integral with and extending outwardly from one another in different directions with the at least two elements received in response to boiling of the liquid core inside the crust and solidification of the liquid core boiled out of the crust.

24. A method as set forth in claim 23 wherein the step of forming the active layer is further defined by forming rods and fibers of the at least two elements.

25. A method as set forth in claim 24 wherein the step of forming the active layer is further defined by sublimating carbon from a vapor phase onto the crust in the form of the rods and the fibers extending from the rods in a generally perpendicular fashion as the liquid core is boiled out of the crust.

26. A method as set forth in claim 25 wherein the step forming the active layer is further defined by solidification and sublimation of the rods and fibers with one another and the metal tape.

27. A method as set forth in claim 26 wherein the step of forming the active layer is further defined by forming the active layer with the rods and the fibers forming a porous structure of the active layer as the rods and the fibers are fusibly connect with one another.

28. A method as set forth in claim 27 wherein the step of forming the active layer is further defined by forming a grid of a three dimensional configuration.

29. A method as set forth in claim 28 wherein the step of forming the grid is further defined by forming pores between the rods extending from a granule and the fibers homogeneously extending from each rod.

30. A method as set forth in claim 29 including the step of providing a camera pressurized for up to 10⁻⁶ TORR of for generating an aerosol from drops of liquid carbon each having a diameter of 1-10 μn.

31. A method as set forth in claim 29 including the step of metal evaporation conducted simultaneously with carbon layer formation.
